(19) United States
(12) Patent Application Publication
(10) Pub. No.: US 2006/0108391 A1
(43) Pub. Date: May 25, 2006

(54) Pneumatic fastener

(76) Inventor: Jeremy D. Leasure, Jackson, TN (US)

Correspondence Address: THE BLACK & DECKER CORPORATION, 701 EAST JOPPA ROAD, TW199, TOWSON, MD, 21286, US

(21) Appl. No.: 11/029,178

(22) Filed: Jan. 3, 2005

Related U.S. Application Data
(60) Provisional application No. 60/533,645, filed on Dec. 31, 2003.

(51) Int. Cl. B25C 5/06

(52) U.S. Cl. 227/120

(57) ABSTRACT

The present invention is directed to a fastener device having a magazine in which at least a portion of the interior of the magazine observable from multiple orthogonal orientations, to permit observation of fasteners to be secured or the lack thereof. In an aspect of the invention, the apparatus includes a driver housing constructed to encompass a driver assembly for securing fasteners. A handle for being manipulating the fastener device is connected to the driver housing. A magazine configured to contain fasteners to be secured is coupled to the driver housing. In an embodiment, a magazine is a stick or linear magazine which includes an interior portion which is observable from at least two orthogonal positions.

### CROSS REFERENCE

The present application claims priority under 35 U.S.C. §119(e) to U.S. Provisional Patent Ser. No. 60/533,645, entitled: Pneumatic Fastener, filed on Dec. 31, 2003, which is hereby incorporated by reference in its entirety.

### FIELD OF THE INVENTION

The present invention relates to the field of construction/woodworking and particularly to a pneumatic fastener.

### BACKGROUND OF THE INVENTION

Fastener devices such as pneumatically driven devices and combustion driven fasteners have proliferated within both the construction and woodworking industries. Fastener devices allow the user to efficiently secure workpieces together without the drawbacks associated with manual nailing/stapling, the tedious repetition of securing screws, or the time and placement associated with gluing.

Fastener device configurations vary based on the fastener to be secured. While framing nailers, or nailers configured to drive large nails such as sixteen penny nails, are usually large, brad nailers for driving brads or small pneumatic staplers are usually of a small configuration to allow the nailer to extend into confined or awkward spaces. For example, brad nailers are often utilized when assembling cabinets, fastening crown molding (e.g., tight corners), and the like where small confines limit operability of a fastener device.

Due to workpiece constraints, small nails such as brads or small staples often are toe-nailed or secured at angles other than perpendicular to a first workpiece. A contact safety may be included in a pneumatic fastener to prevent actuation of the fastener device unless the nose of the driver housing is contacted with a workpiece. A contact safety typically is spring biased such that a mechanical catch, extension or the like interferes with operation of a trigger to prevent a fastening event from occurring when the safety is not in contact with an object. In some instances, a contact safety may be implemented to initiate a fastening event (i.e., contact actuation mode) so that a user may cause a fastener to be driven when the safety tip is depressed towards the body of the fastener device. Drawbacks to contact safety configurations, and particularly small frame fastener devices, include the size of the safety tip relative to the nose of the driver housing and the location of the mechanism relative to the nose of the housing (i.e., the contact tip is disposed on the front of the driver housing tip relative to the location at which a user grasps the nailer. Disposing the contact forward of the drive chamber nose limits the accessibility of the device in corners thereby necessitating manual fastening (such as with a hammer and nail set) or requiring a different fastening technique.

Fastener devices typically include magazines for retaining fasteners such as nails/staples prior to utilization. Magazines often limit observation of remaining fasteners to a single side such that a user is required to turn the device (from a standard orientation wherein the nose is directed toward a workpiece) to observe the status of the magazine. Additionally, magazines often have openings which extend (substantially) their entire length, for stick type magazines. These openings, while permitting limited observation, may permit the ingress of dust/debris which may foul the magazine and in some instances even prevent proper operation. Additionally, the configuration of such magazines may not be aesthetically pleasing or may include components (such as a nail pusher) which extends beyond the body of the magazine. As a result of the foregoing, the magazine may mar a workpiece, a magazine component may become snagged, the magazine may not be efficiently manipulated during loading (e.g. grasped when inserting fasteners), or the like.

Fastener devices and in particular pneumatic fasteners often include an open trigger mechanism. For instance, an open trigger may be formed from a curved flap or extension of metal which is pivotally mounted to a housing. A trigger may be biased away from a pneumatic valve assembly for actuating the driver. As a result, dust/debris may enter between the trigger assembly and the pneumatic valve assembly causing fouling and the like. Additionally, a user may experience discomfort after initiating numerous fastening events such as if a user's finger wraps around the trigger flap and/or due to inconsistent contouring adjacent the trigger. Further, a user may inadvertently catch a portion of his/her hand or finger between the trigger and the tool body thereby leading to user dissatisfaction.

In additional instances, a fastener device may become marred or cosmetically damaged due to dropping or resting the device on its side (i.e., resting a nailer along its length on a rough or uneven surface). Additionally, a workpiece may be marred or its surface damaged by inadvertent contact between a nailer housing, i.e., the driver housing, and the workpiece. Moreover, a user may wish to extend his/her finger/thumb along the driver housing so as to aid in directing the nose when positioning the fastener device. In other instances, a user may wish to position his/her thumb partially about the driver housing during utilization.

An additional difficulty experienced with fastener devices is the inability of a fastener device to initially indicate the depth to which a fastener will be set or driven. Fastener devices are typically configured with drivers which are capable of driving fasteners to various depths with respect to the nose of the driver housing. For example, upon initially utilizing a pneumatic fastener, a user often must conduct several test firings or fastening events to determine the proper recess for the nail head prior to continuing with the project. In the previous example, the pneumatic fastener is configured to drive a fastener through out a range of depths such as from fully recessed (wherein the nail head is below the surface of the workpiece) through a proud position (wherein the nail head extends above the surface of the workpiece). Thus, while the depth to which a fastener is driven is adjustable, fastener devices fail to provide an indication of the depth to which a fastener is to be driven (i.e., where within the range the nail head will be disposed). As a result a user may have to utilize a hammer and nail set to properly recess a nail if the head is left proud of the workpiece.

Therefore, it would be desirable to provide a fastener device having a magazine capable of observation from at least two orthogonal positions.

### SUMMARY OF THE INVENTION

Accordingly, the present invention is directed to a fastener device having a magazine of which at least a portion of the interior of the magazine observable from multiple orthogonal orientations. In an aspect of the invention, the apparatus includes a driver housing constructed to encompass a driver assembly for securing fasteners. A handle for being manipulating the fastener device is connected to the driver housing. A magazine configured to contain fasteners to be secured is coupled to the driver housing. In an embodiment, a magazine is a stick or linear magazine which is observable from at least two orthogonal positions.

In an additional aspect, a fastener device includes a substantially entirely enclosed magazine, for preventing the ingress of dust and debris, which is configured such that at least a portion of the interior of the magazine observable from various orthogonal orientations, such as above the magazine (i.e., observable adjacent a handle). In an aspect of the invention, the apparatus includes a driver housing constructed to encompass a driver assembly for securing fasteners. The handle being for manipulating the fastener device to a desired orientation is connected to the driver housing. A magazine for containing fasteners to be secured is coupled to the driver housing. In an embodiment, a magazine is a stick or linear magazine which is observable from at least two orthogonal positions.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an isometric view of a fastener device in accordance with an aspect of the present invention;

FIG. 2 is a partial side view of a fastener device including a contact safety disposed towards a handle member and a magazine observable from at least two orthogonal positions in accordance with an aspect of the present invention;

FIG. 3 is a side view of a fastener device in accordance with an aspect of the present invention;

FIG. 4 is a partial end view of a fastener device having contact pads;

FIG. 5 is a partial isometric view of a fastener device including a contact safety disposed towards a handle member and a magazine observable from at least two orthogonal positions in accordance with an aspect of the present invention; and

FIG. 6 is a partial side view of fastener device including a fastener depth indicator system in accordance with an aspect of the invention.

### DETAILED DESCRIPTION OF THE INVENTION

Reference will now be made in detail to the presently preferred embodiments of the invention, examples of which are illustrated in the accompanying drawings. It is to be appreciated that corresponding reference numbers refer to generally corresponding structures. While a pneumatic fastener device is discussed, those of skill in the art will appreciate that the principles of the present invention may be applied to combustion driven fastener devices as well. Additionally, while the majority of this disclosure is directed to small frame brad nailers or staplers, a variety of pneumatic fastener devices having a variety of configurations may benefit from the principles of present invention. Those of skill in the art will appreciate that while the present disclosure is directed to a fastener device having a stick or straight magazine which is substantially parallel to a handle member the magazine may be angled as desired with respect to a driver housing/handle and the magazine may be configured to accept fasteners of a different arrangement such as arranged in a coil or the like. It is the intention of this disclosure to encompass and include such variation.

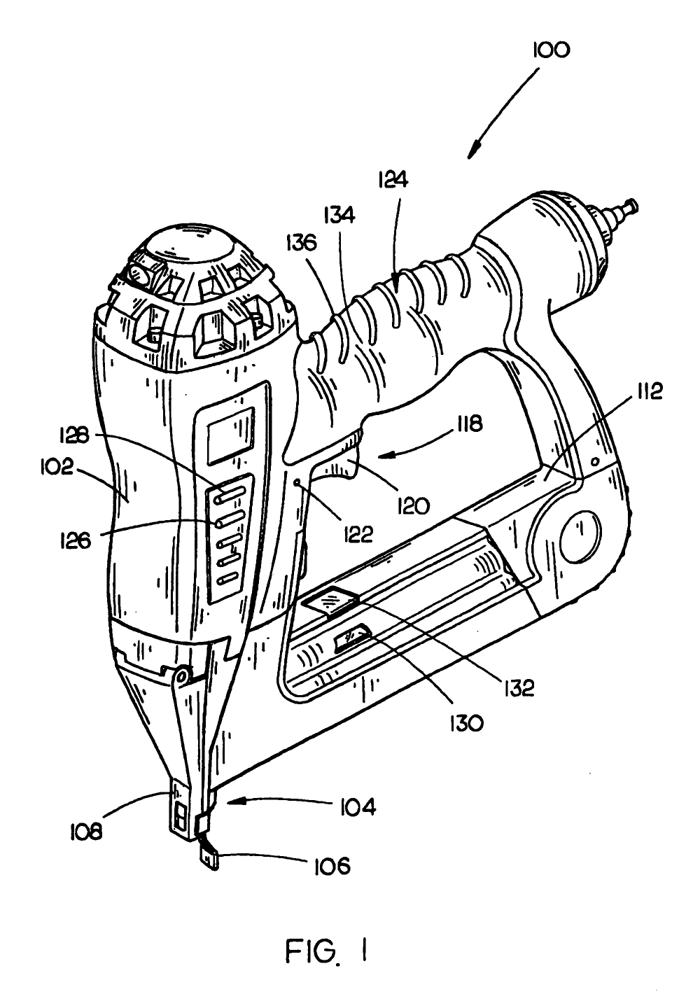

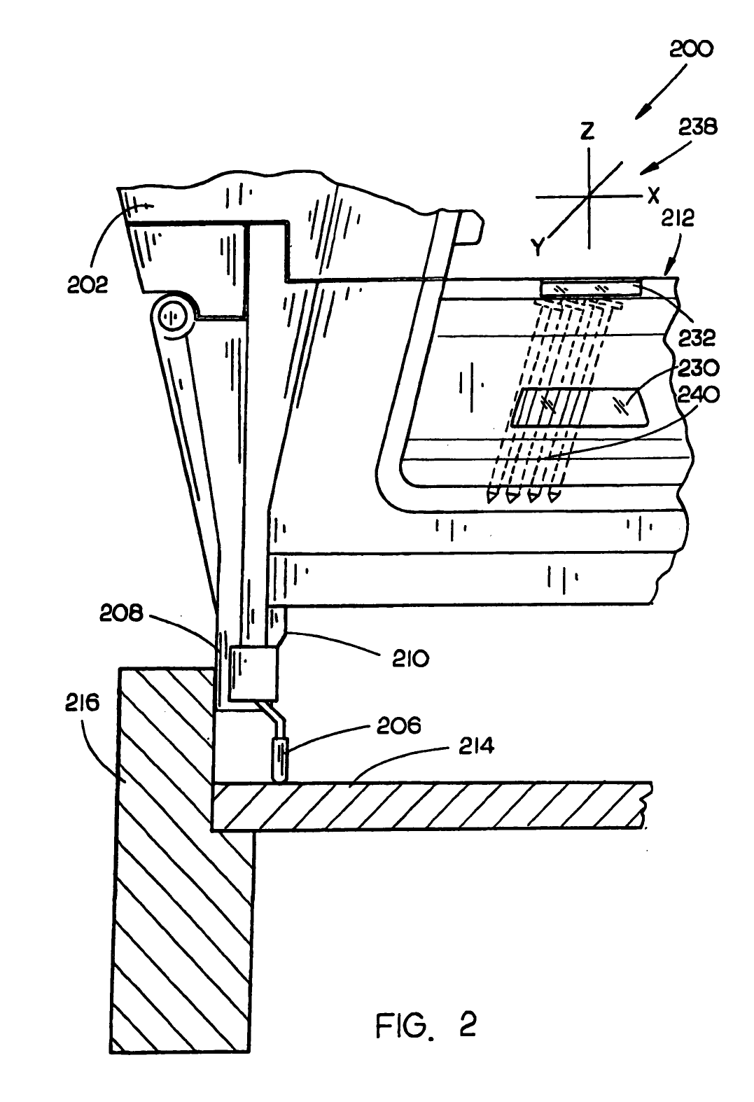

Referring to FIGS. 1 and 2, a pneumatic fastener 100 in accordance with an embodiment of the present invention is disclosed. In the present embodiment, the pneumatic fastener 100 is a brad nailer or a nailer configured to secure nails generally in the range of approximately less than an inch to approximately two inches, further brad nails are typically finish nails having a minimal head in comparison to the shank of the nail. As discussed previously brad nailers, in particular, are implemented in a variety of situation in which the nail is to be secured in a awkward position or in a confined space such as when building cabinetry, securing crown molding, and the like.

The brad nailer 100 includes a driver housing 102 for containing a driver assembly for securing a fastener. A contact safety assembly 104 is included in the pneumatic fastener to prevent actuation of a driver assembly (in the present case a pneumatic driver assembly includes a reciprocating piston having a driver blade for contacting a fastener disposed in the path of the driver blade) when the contact safety tip 106 is not in contact with a workpiece. In further instances, the contact safety assembly may be implemented to actuate a fastening event or firing of the nailer 100. The contact safety assembly 104 includes intermediate linkage 110 for coupling the contact safety tip 106 to the driver assembly/the pneumatic control system for regulating operation of the driver assembly.

In the present embodiment, the contact safety assembly includes a spring for biasing the safety tip away from the driver housing 102 thereby locking-out the trigger. Additionally, as discussed below, an adjuster may be included in a contact safety assembly 104 for varying the depth to which a nail or fastener is set (i.e., recessed). For example, a threaded adjuster wheel is engaged with a threaded intermediate linkage so as to permit nail set depth adjustment. In the current embodiment, the contact safety tip 106 is configured to slide axially towards/away from the nose 108 of the driver housing 102. For example, the contact safety/driver housing is configured with a corresponding groove and engaging tab/extension or the like to maintain alignment of the tip 106 with respect to the nose 108. The contact safety tip 106 is disposed toward the rear of the brad nailer (as generally orientated in FIG. 1) or generally towards a fastener storage magazine 112 for containing nails to be secured. Coupling the contact tip 106 towards the magazine 112 permits the nose of the driver housing 108 to be more easily positioned in a confined space. For example, as may be observed in FIG. 2, the nose of the driver housing 208 is capable of being disposed in close proximity to the interface between a first and second workpieces 214 and 216 (which are generally perpendicularly orientated). In the foregoing manner, a nail may be driven substantially perpendicular to the first workpiece, thereby minimizing the need for toe nailing, while ensuring proper depressing of the safety (movement of the safety tip toward the driver housing 202). Additionally, when installing crown molding or the like the contact safety tip 106 is disposed toward the main portion of the crown molding (when nailing in a corner) thereby ensuring sufficient actuation of the safety to release the trigger. In a preferred embodiment, the contact safety tip 106 is contoured generally to the shape of the driver housing nose 208 so as to minimize the overall footprint or contact surface area of the end of the driver housing nose 208 and the contact safety tip 206. In the current embodiment, the contact safety tip 206 includes a non-marring ridged plastic tip for preventing inadvertent damage to a workpiece.

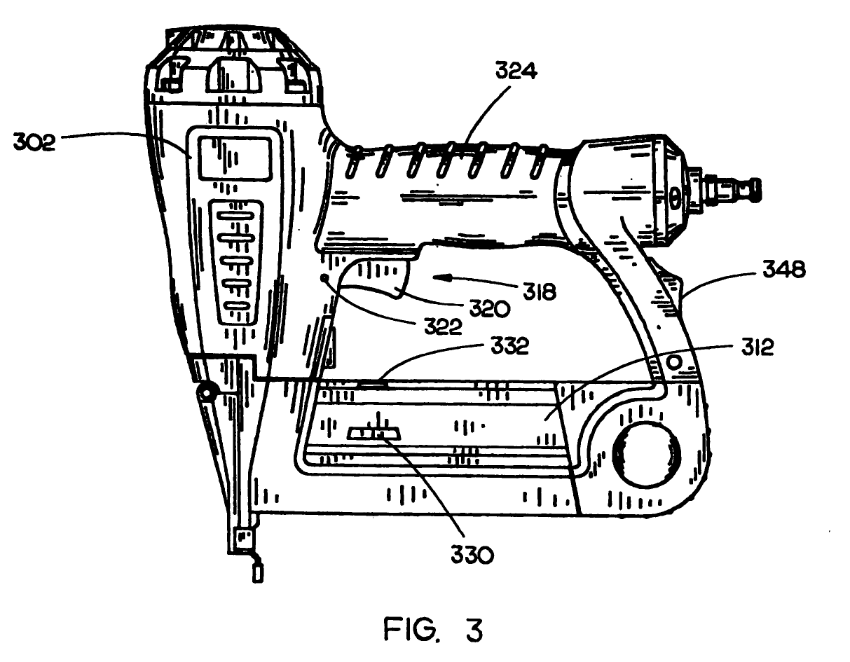

Referring now to FIGS. 1 and 3, in a further aspect of the present invention a pneumatic fastener having an enclosed trigger assembly 118 is discussed. The trigger assembly 118 includes a trigger 120 formed as an enclosure such as a multi-sided enclosure with enclosed side walls so as to prevent the ingress of dust/debris into a valve assembly for controlling operation of the driver assembly associated with a tab type trigger.

Preferably, the trigger 120 is configured to substantially enclose the valve assembly and a spring for biasing the trigger into a non-actuating position. In the present embodiment, the trigger 120 is pivotally connected via a pivot pin 122 generally at the interface of a handle member 124 and the driver housing 102 to permit efficient positioning of the pneumatic fastener, promote control of the nailer, and the like. In the present embodiment, the handle 124 is coupled to the driver housing 102 generally adjacent an end of the driver housing 102 opposite the nose 108 or the end of the driver housing from which fasteners are ejected. Including an enclosed trigger 120 may prevent the user from inadvertently catching a portion of their hand/finger between the handle 124/driver housing 102 as well as providing for ergonomic utilization. Additionally, a portion of the handle/housing adjacent the trigger 120, in an embodiment, may be contoured in order to extend about the periphery of the trigger 120 such that the trigger 120 extends at least partially into/out of the handle when the trigger 120 is activated thereby providing a comfortable trigger pull for a user. In an advantageous embodiment, a trigger is formed of a rigid plastic material such as a nylon or ABS (acrylonitrile butadiene styrene) polymer in order to reduce the overall weight of the nailer 100. Additionally, surface texturing may be included on the end of the trigger 120 so as aid in manipulation, wick sweat, and the like.

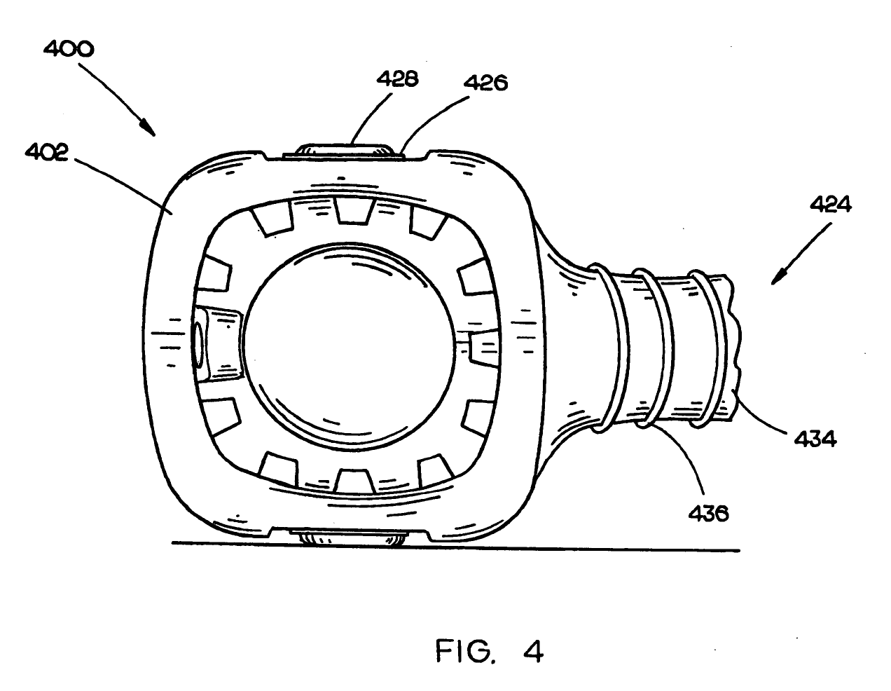

Referring to FIGS. 1 and 4, in a further aspect of the invention, a fastener device such as a pneumatic brad nailer 100 includes a contact pad 128 secured to the driver housing 102. Preferably, a contact pad 128 is disposed on a side of the driver housing or on a side generally perpendicular to the handle 124. In the present embodiment, the contact pad 128 is adhered to the exterior surface of the driver housing. The contact pad may be at least partially received in a recessed area of the housing 102. In further embodiments, a contact pad 128 may be mechanically fastened to the housing 102 (such as by a fastener(s) (e.g., a screw)), secured via a mechanical interconnect (such as an integrally formed protrusion or molded to the housing directly), or the like.

Preferably, the contact pad is formed of rigid plastic, of an elastomeric type material or of a combination material such as a co-molded rigid/elastomeric material. Forming the contact pad of a rigid plastic may allow for deformation of the contact pad without damaging the adjacent driver housing coating. A co-molded elastomeric or rubber material may be implemented in instances where a user wishes to grasp or merely contact the driver housing such as by resting his/her thumb or forefinger on a contact pad or to have an increased coefficient of friction (such as if the pneumatic fastener is to be rested on an inclined surface, e.g., a roof). For instance, a user may tend to pinch the driver housing when positioning the nailer on a workpiece.

As may be best observed in FIG. 4, a contact pad 428 may extend substantially equal to or greater than the exterior surface of the driver housing 402. Disposing the contact pad 428 so that the pad extends beyond the outer surface of the driver housing 402 may prevent inadvertent damage to the housing 402/cosmetic damage to the housing. For example, if the nailer is dropped on its side or is rested on a rough surface. In a further embodiment, a plurality of ridges 126 extend from the exposed surface of the contact pad 426 to aid in grasping, assist in retaining the nailer on a surface, and the like. Preferably, a contact pad 128 extends longitudinally along the driver housing 102 to prevent or minimize inadvertent damage to the housing between the housing cap (terminal portion of the drive housing generally opposite the nose 108) and the nose 108 of the drive chamber. In additional examples, a contact pad contours generally with the outer surface of the housing 102. For example, the contact pad may be curved so as to correspond to curved surface of a generally cylindrical portion of a driver housing 102. Preferably, the nailer 400 rests on the contact pad and/or in conjunction with the nose 108 of the driver housing when the nailer is disposed on a side including the contact pad.

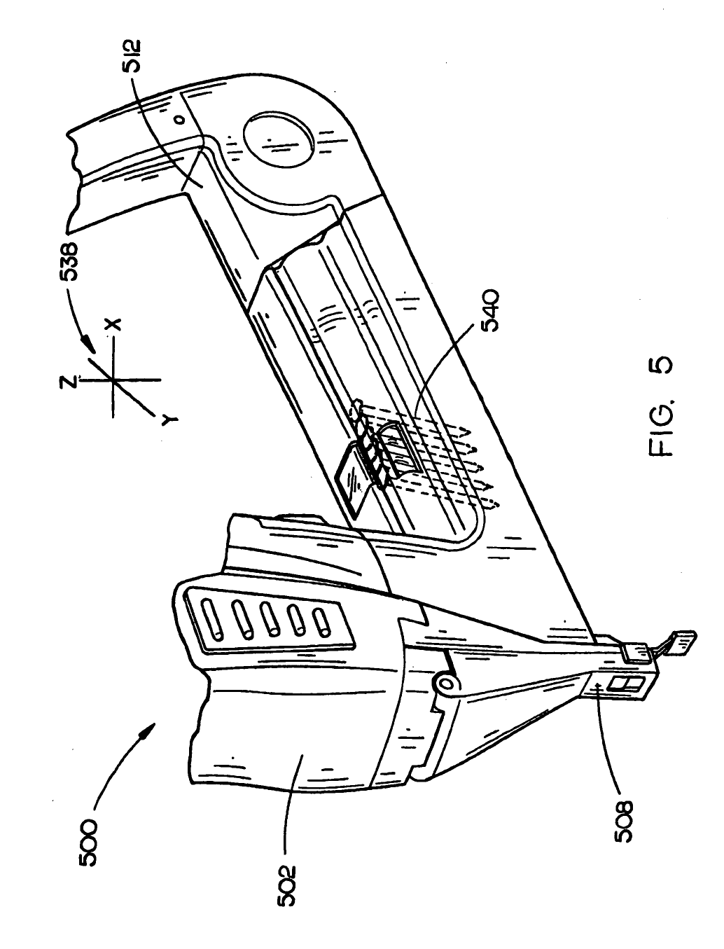

Referring to FIGS. 1-3 and 5, in a further aspect of the invention, a fastener device includes a magazine 124 configured for observing the interior of the magazine for containing fasteners to be secured, thus fasteners disposed in the observable portion of the magazine, from at least two orthogonal positions or orientations 238 with respect to the magazine 112. For example, a user may observe the interior of a portion of the magazine (i.e., any fasteners present in the viewable portion) from various positions during normal utilization. In another example, a user is capable of observing, at least a portion of, the interior of the magazine while looking along the length of the driver housing 302 from the handle 324 end. The magazine 512 is configured to deliver fasteners to be secured into the path of a driver included in a driver assembly encompassed in driver housing 502. For example, as may be observed in FIGS. 3 and 5, a magazine in accordance with the present embodiment permits observation from along a side of the magazine (a longitudinal side) and from adjacent the top of the magazine or from a position or orientation adjacent the handle 324. In the foregoing manner, the number of fasteners 240 (FIG. 2) may be ascertained during normal operation (i.e., when a user observes the magazine from a handle side) without having to manipulate or change the orientation of the nailer 200. For instance, only a portion of the interior of the magazine may be observable such disposing an observation opening adjacent the driver housing 502 in order to permit observation when a limited number of fasteners 540 are present (i.e., when ten or fewer fasteners remain or when one third of the magazine capacity is available). In a preferred embodiment, a magazine 512 is substantially entirely enclosed to prevent ingress of dust/debris. Referring to FIG. 5, for example, the magazine may be enclosed along a stick magazine's longitudinal sides to prevent fouling of the mechanism. Those of skill in the art will appreciate a magazine forwarding mechanism (e.g., a spring biased mechanism) may include a rear closure (including a locking latch 348 for locking the closure). In the previous instance, transparent windows 530, 532 such as made of transparent plastic are included to permit observation of at least a portion of the magazine interior while preventing contamination of the fasteners to be secured or driven. In the present aspect, a fastener device includes a driver housing 102 for containing or encompassing a driver assembly for driving fasteners. A handle 124, configured to be grasped by a user for manipulating the fastener device, is connected to the driver housing 124. Those of skill in the art will appreciate that the principles of the present invention may be implemented with variously configured fastener magazines, such as a coil magazine, and the like. In an advantageous embodiment, at least a portion of the interior of the magazine (e.g., the observable portion) is coated or formed of a material which contrasts with contained fasteners. For example, the interior may be formed with a red interior to emphasize the presence/absence of fasteners. Furthermore, a magazine may be marked or include graduations to indicate the quantity of fasteners present.

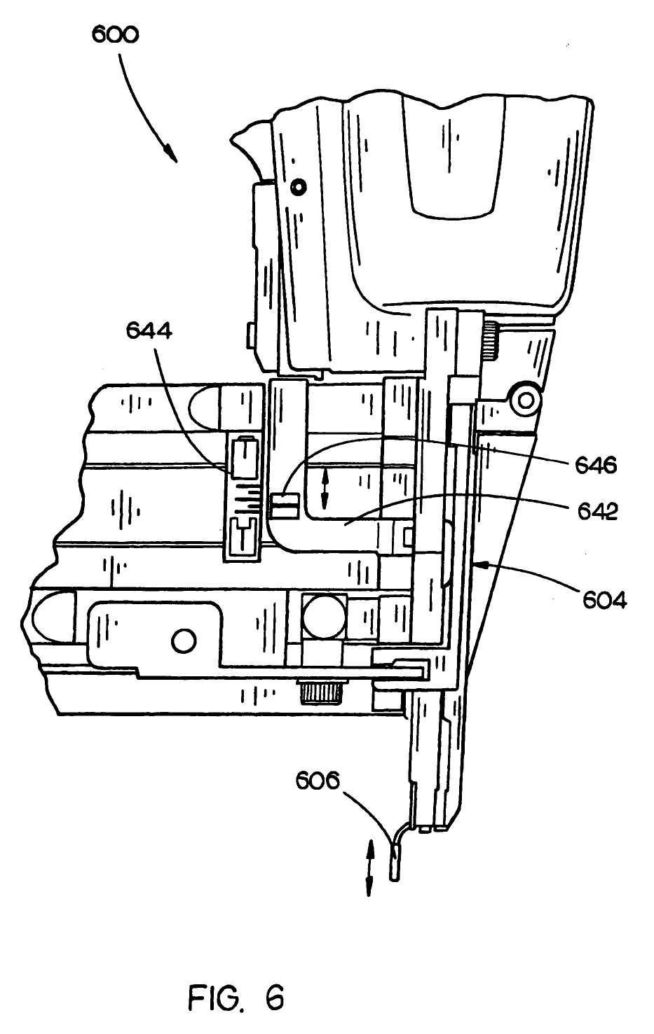

Referring to FIG. 6, in a further aspect of the present invention a fastener device 600 including a fastener depth indicator system is discussed. A depth indicator system of the present invention permits identification of the relative depth of recess or set depth to which the fastener device is set or has been pre-configured. For instance, a driver assembly may be adjusted from leaving the head of a fastener proud (or above the surface of the workpiece) to some height through fully set or the maximum depth to which a fastener may be recessed or set. The system of the present invention allows a user to identify the depth to which a fastener is to be driven or secured relative to the range the fastener device/driver assembly is capable. In the foregoing manner, the number of test firings or fastening events is minimized or eliminated. A graduation or scale range 644 is disposed on a non-moving component of the fastener device 600 (i.e., a component which adjacent an intermediate linkage 642 of a contact safety assembly. Preferably, the graduation range corresponds to the range of available recess capable by the fastener. Those of skill in the art will appreciate that a graduation range may be adhered to the component (such as printed on an adhesive sticker or laminated tag adhered to the component), engraved in the component, or applied as part of a surface treatment (e.g., as part of the component's protective coating), fastened to the component (e.g., riveted to the component), in a combination thereof, and the like.

An indicator 646 may be provided on the intermediate linkage 642 of the contact safety assembly. An indicator 646 may be provided in substantially a same manner as that of the graduation range. Those of skill in the art will appreciate that a variety of intermediate linkages extending between a contact safety tip 606 and the driver assembly may be utilized without departing from the scope and spirit of the present invention. A thumb wheel or the like adjuster may be included in a contact safety system to adjust the depth to which a fastener is to be driven by a driver assembly (e.g., a pneumatic driver assembly). Correspondingly, the position of the intermediate linkage, and thus the indicator 646 is varied verses a fixed component included in the fastener. For example, an adjuster may be manipulated to extend the contact safety tip (thus extending the linkages) away from the nose of the driver housing thereby adjusting the depth to which a fastener is to be secured. In the present embodiment, the contact safety system is operationally coupled to the driver assembly such as via a valve controller or the like to regulate operation of the driver assembly. In combustion type fastener, an adjuster may regulate the amount of combustible material entering the combustion chamber or the like.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A fastener device, comprising:
a driver housing for encompassing a driver assembly for securing fasteners;
a handle connected to the driver housing, the handle being configured for being grasped by a user to manipulate the fastener device; and
a generally linear magazine being configured and arranged to contain fasteners to be secured by the driver assembly,
wherein generally linear magazine is configured to permit observation of at least a portion of the interior of the generally linear magazine from at least two orthogonal positions with respect to the magazine.

2. The fastener device of claim 1, wherein the interior of the generally linear magazine is observable from a side of the magazine adjacent the handle.

3. The fastener device of claim 1, wherein the generally linear magazine includes at least two windows.

4. The fastener device of claim 3, wherein the at least two windows are formed of transparent plastic.

5. The fastener device of claim 1, wherein the generally linear magazine is configured to permit observation of the interior of the magazine adjacent the driver housing.

6. The fastener device of claim 1, wherein the generally linear magazine is substantially entirely enclosed.

7. The fastener device of claim 1, wherein the driver assembly is pneumatically operated.

8. The fastener device of claim 1, wherein the observable interior portion of the magazine is at least one of formed of or coated with a material having a color contrasting with a metallic color.

9. A pneumatic fastener, comprising:
a driver housing for encompassing a pneumatic driver assembly for securing fasteners;
a handle connected to the driver housing, the handle being configured for being grasped by a user to manipulate the pneumatic fastener; and
a magazine coupled to the driver housing, the magazine being configured to contain fasteners to be secured by the pneumatic driver assembly, the magazine being configured to substantially entirely encompass fasteners to be contained,
wherein magazine is configured to permit observation of at least a portion of the interior of the magazine from at least two orthogonal positions with respect to the magazine.

10. The pneumatic fastener of claim 9, wherein the interior of the magazine is observable from a side of the magazine adjacent the handle.

11. The pneumatic fastener of claim 9, wherein the magazine includes at least two windows.

12. The pneumatic fastener of claim 11, wherein the at least two windows are formed of transparent plastic.

13. The pneumatic fastener of claim 9, wherein the magazine is configured to permit observation of the interior of the magazine adjacent the driver housing.

14. The pneumatic fastener of claim 9, wherein the magazine is configured to permit observation of substantially all the fasteners contained within the magazine.

15. The pneumatic fastener of claim 9, wherein the observable interior portion of the magazine is at least one of formed of or coated with a material having a color contrasting with a metallic color.

16. A pneumatic fastener, comprising:
a driver housing for encompassing a pneumatic driver assembly for driving fasteners;
a handle connected to the driver housing, the handle being configured for being grasped by a user to manipulate the pneumatic fastener; and
means for containing fasteners to be secured by the pneumatic driver assembly, the containing means being configured to permit observation of at least a portion of the interior of the containing means from at least two orthogonal positions with respect to the containing means.

17. The pneumatic fastener of claim 16, wherein the interior of the containing means is observable from a side of the containing means adjacent the handle.

18. The pneumatic fastener of claim 16, wherein the containing means includes at least two windows.

19. The pneumatic fastener of claim 16, wherein the containing means is configured to permit observation of substantially all the fasteners contained within the containing means.

20. The pneumatic fastener of claim 16, wherein the observable interior portion of the containing means is at least one of formed of or coated with a material having a color contrasting with a metallic color.
